(19) United States
(12) Patent Application Publication
(10) Pub. No.: US 2008/0184879 A1
(43) Pub. Date: Aug. 7, 2008

(54) PISTON HAVING IMPROVED WEAR RESISTANCE AND METHOD OF MAKING

(76) Inventors: Nicholas LoBiondo, Macomb, MI (US); Bruce Inwood, Fenton, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/970,929

(22) Filed: Jan. 8, 2008

Related U.S. Application Data
(60) Provisional application No. 60/884,135, filed on Jan. 9, 2007.

(51) Int. Cl. F16J 1/01; B23P 15/10

(52) U.S. Cl. 92/172; 29/888.04

(57) ABSTRACT

A piston formed from an Al—Si alloy having an average Si composition includes a high wear region having a surface that is Si-rich with respect to the average Si composition of the Al—Si alloy. The surface of the predetermined high wear region is treated, as by etching, to selectively remove Al from the surface to produce the Si-rich region. The Si-rich region has improved resistance to wear. The piston may be treated to produce one or more high wear regions which are Si-rich with respect to the average Si composition of the alloy. High wear regions may include the annular grooves for receiving a piston ring, the piston skirt and the pin bore.

This application claims priority to U.S. Provisional Application Ser. No. 60/884,135, filed Jan. 9, 2007 and is incorporated herein by reference.

### BACKGROUND OF THE INVENTION

1. Technical Field

This invention relates generally to pistons and methods of their manufacture. More particularly, the invention relates to pistons formed from Al—Si alloys having Si-rich regions formed in predetermined high wear regions, and a method for forming the Si-rich regions.

2. Related Art

Al—Si alloys are commonly used in the manufacture of pistons for application in internal combustion engines for automotive and other applications. While Al—Si alloy pistons have generally acceptable performance in a wide variety of internal combustion engine applications, there remains a need to improve the performance of pistons manufactured from these alloys with respect to several critical high friction and/or high wear regions of these pistons.

One such high wear region relates to the portion of the piston surface which functions as the interface between the piston and piston ring. In the vast majority of internal combustion engines which use reciprocating pistons, the pistons are surrounded by a plurality of piston rings to create a seal between the piston and the cylinder wall to seal the combustion chamber and high temperature gases contained therein from the oil sump and lubricating oil used to reduce the friction between the piston ring and cylinder wall. The piston ring is typically captured within a circumferential groove which is formed on the circumferential surface of the piston. The ring is sized relative to the groove so that it is free to rotate within the groove during operation of the engine and reciprocation of the piston within the cylinder wall. It is important that the piston ring be movable with respect to the groove because its relative movement results in more uniform heat transfer between the piston and the cylinder walls, as well as preventing scoring of the ring and/or cylinder wall due to non-uniform features or asperities found on the outer surface of the ring or due to the entrapment of dirt or other particulate matter between the outer surface of the ring and the cylinder wall. If the ring does not rotate, such items are known to cause scoring of the cylinder wall and/or the outer surface of the ring.

There is a particularly critical time period for new internal combustion engines frequently referred to as the break-in period during which the moving surfaces of the piston and piston ring adjust so as to operatingly conform to one another. During this period, the interface between the piston and piston ring is particularly susceptible to a condition known as microwelding. Microwelding refers to the propensity for the piston ring to stick to the sidewalls of the piston groove, particularly to the upper surface or lower surface of the groove. Microwelding is a phenomena in which areas of contact between the piston and piston ring become welded to one another as a result of the pressure and temperature experienced by the components in the areas of contact, either due to the heat and pressure associated with combustion process, or frictional heating associated with the contact between the piston and piston ring or a combination of both of them. If during the break-in period, the piston and piston ring maintain free movement between them, the respective surfaces will mate uniformly, microwelding will not occur, and proper operation of the piston will be maintained.

If the piston includes a skirt piston, another high wear region is associated with the surface of the skirt. Numerous skirt configurations, including articulated and fixed configurations and coatings have been implemented to reduce the friction associated with the operation of the skirt, including tin coatings and more recently, various polymeric coatings, including various epoxy and/or polyamideimide coatings which include particles of solid lubricant dispersed therein, such as graphite, molybdenum disulfide, polytetrafluoroethylene and hexagonal boron nitride (HBN). A critical aspect of these coatings is their adhesion to the outer surface of the piston skirt.

Yet another high wear region includes the pin bosses which have a pin bore that is adapted to receive a piston pin for connecting the piston to a connecting rod. The pin bore or bores are also high wear, high friction surfaces which are known to be subject to scuffing and other wear processes.

Therefore, it is desirable to adapt these high friction, high wear regions of pistons formed from Al—Si alloys so as to improve their operating performance with respect to the friction and wear processes described above.

### SUMMARY OF THE INVENTION

The present invention is directed to a piston formed from an Al—Si alloy having an average Si composition and a predetermined high wear region having a surface that is Si-rich with respect to the average Si composition of the Al—Si alloy. The surface of the predetermined high wear region is treated, as by etching, to selectively remove Al from the surface to produce an Si-rich region with improved resistance to wear. One or more high wear regions of the piston may be treated to produce a surface that is Si-rich with respect to the average Si composition of the alloy.

According to one aspect of the invention, the high wear region is a groove surface associated with a circumferential groove, such as a piston ring groove, formed in the outer surface of the piston. The groove surface is treated, as by etching, to selectively remove Al from the surface to produce an Si-rich region. The Si-rich groove surface has improved resistance to microwelding between the piston and a piston ring during operation of the piston in an internal combustion engine as the piston ring is compressed against and slides over the groove surface.

According to a second aspect of the invention, the high wear region is a predetermined portion of the surface of the piston skirt which is either attached to or adapted for attachment to the piston. The piston skirt surface is again treated, as by etching, to selectively remove Al from the surface to produce an Si-rich region. The Si-rich piston skirt surface has improved resistance to wear associated with the bearing of the piston skirt on the cylinder sidewall of an internal combustion engine. The Si-rich region also has a greater surface roughness and a more porous surface which further improves the retention or adhesion of a lubricant coating placed on the piston skirt over the Si-rich region, and which further improves the resistance of the piston skirt to scuffing and other wear phenomena with respect to sliding of the piston skirt over the surface of the cylinder sidewall during the operation of an internal combustion engine.

According to a third aspect of the invention, the high wear region is a surface of a pin bore associated with a pin boss of the piston. The pin bore surface is treated, as by etching, to selectively remove Al from the surface to produce an Si-rich region. The Si-rich pin bore surface has improved resistance to wear associated with the bearing of the pin bore surface on the wrist pin used to secure the piston to the connecting rod of an internal combustion engine. The Si-rich region also has a rougher surface finish and a more porous surface which further improves the retention or adhesion of a lubricant coating placed on the surface of the pin bore, and which further improves the resistance of the pin bore to scuffing and other wear phenomena with respect to rotation of a piston pin within the bore during operation of the engine.

According to a fourth aspect of the invention, the invention comprises a method of forming an Si-rich surface in a high wear region of an Al—Si alloy piston. The method comprises the steps of forming a piston from an Al—Si alloy having an average Si composition and having at least one high wear region where it is desired to form an Si-rich surface; selectively removing Al from the surface of the piston in the high wear region to produce an Si-rich surface. According to one aspect of the invention, selectively removing the Al in the high wear region comprises the additional steps of isolating the high wear region from the remainder of the piston and applying an etchant that is adapted to remove the Al-rich phase or phases selectively with respect to the Si-rich phases of the particular Al—Si alloy composition.

### BRIEF DESCRIPTION OF THE DRAWINGS

These and other features and advantages of the present invention will become more readily appreciated when considered in connection with the following detailed description and appended drawings, wherein:

FIG. 1 is a perspective view of one embodiment of an Al—Si alloy piston of the present invention.

FIG. 2 is a cross-sectional view of the ring groove and ring groove surface region associated with line 2-2 of FIG. 1.

FIG. 3 is a cross-sectional view of the piston skirt and piston skirt surface region associated with line 3-3 of FIG. 1.

FIG. 4 is a cross-sectional view of the pin bore and pin bore surface region associated with line 4-4 of FIG. 1.

FIG. 5A-C are schematic cross-sectional views illustrating the steps of the method of the invention applied to ring groove surface region.

FIG. 6A is a representative EDX spectra of a high wear surface region prior to the selective removal of Al from the surface;

FIG. 6B is a representative EDX spectra of high wear surface region of the piston after the selective removal of Al from the surface;

FIG. 6C is a representative EDX spectra of a high wear surface region of the piston after the selective removal of Al from the surface and wear testing;

FIG. 7A is an electron photomicrograph of a high wear surface region of the piston prior to the selective removal of Al from the surface; and

FIG. 7B is an electron photomicrograph of a high wear surface region of the piston after the selective removal of Al from the surface.

### DETAILED DESCRIPTION OF THE PREFERRED EMBODIMENT

The present invention is a piston 10 formed from an Al—Si alloy. The Al—Si alloy may be any Al—Si alloy having a predetermined average concentration of both Al and Si which is determined by the application requirements. It is preferred that Al—Si alloys of this invention are eutectic or hyper-eutectic Al—Si alloys. Alloys of the present invention may also include other alloying additions, such as Cu, Mg or Ni, or combinations of them, in order to affect the properties of piston 10. Referring to FIG. 1, piston 10 is generally cylindrical, although other piston shapes may also be utilized. In the embodiment illustrated in FIG. 1, piston 10 has a piston crown 12 and a piston skirt 14, although the present invention is also applicable to pistons which do not include piston skirt 14. In crown 12 there formed a plurality of circumferential or annular grooves 16 which extend radially and inwardly from outer surface 18 of piston 10 in crown 12. Crown 12 also includes a plurality of lands 20 in the outer surface 18 associated with annular grooves 16. Piston 10 also includes two opposing piston pin bosses 22 which extend downwardly from crown 12 and which each also include a pin boss bore 24 which is adapted to receive a conventional piston pin (not shown) in order to connect piston 10 to a conventional connecting rod (not shown). Each pin boss bore 22 has an annular bore surface 26. As noted above, FIG. 1 illustrates one embodiment of a piston of the present invention, however, many other piston designs are known, including various skirted and unskirted designs and various pin boss configurations, which may also be utilized with an Al—Si alloy in accordance with the present invention.

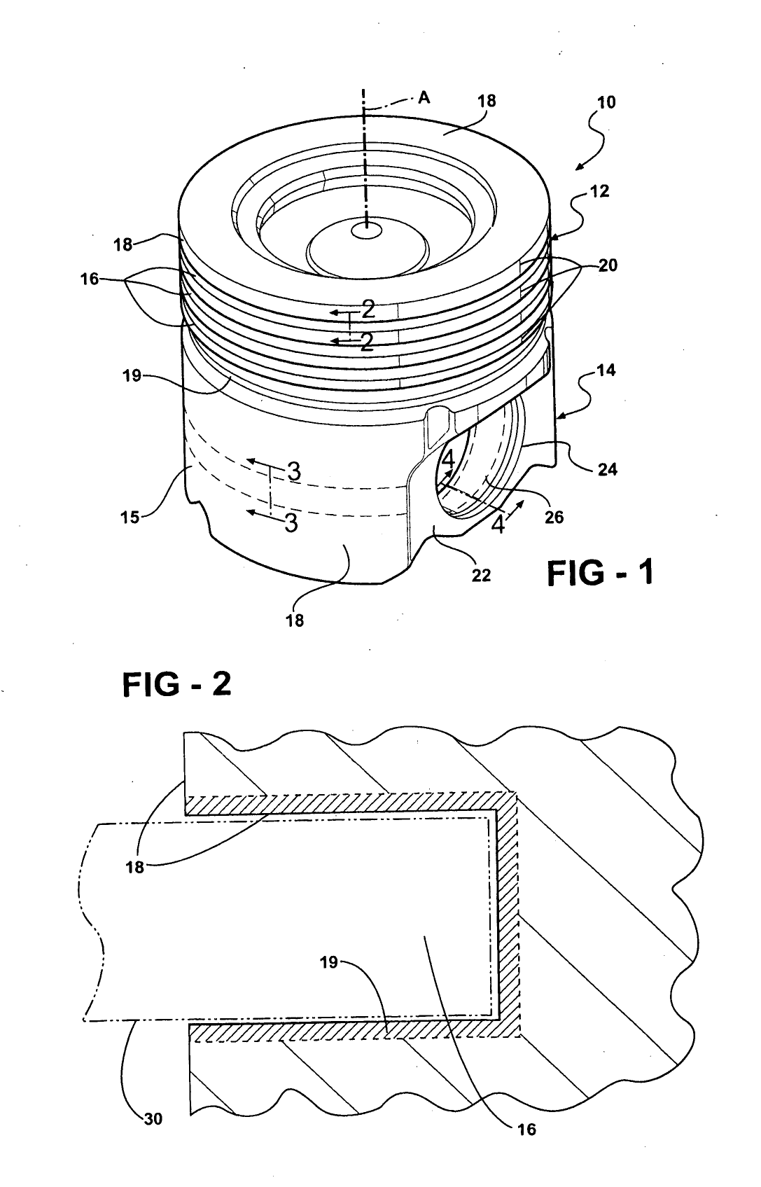

Referring again to FIG. 1, in conjunction with the use of piston 10 in an application such as an internal combustion engine, certain regions on outer surface 18 are subjected to high friction and high wear due to bearing contact between the portions of outer surface 18 in these regions and other components of the engine or other device incorporating piston 10. Several exemplary high friction, high wear regions of piston 10 are identified in FIG. 1 by section lines 2-2, 3-3 and 4-4, which are associated with FIGS. 2-4, respectively. In accordance with the invention, a predetermined high wear surface region 19 of outer surface 18, such as those illustrated in FIGS. 2-4, has a surface with an Si concentration which is greater than the average bulk Si concentration of the alloy. This is also referred to herein as the surface being Si-rich with respect to the average concentration of the alloy. The predetermined high wear region 19 of outer surface 18 is formed by selectively removing Al from the matrix of the alloy leaving the high wear region 19 of outer surface 18 Si-rich with respect to the average or bulk concentration of Si in the alloy. The predetermined high wear surface region may be any region of outer surface 18 where it is desirable to improve the wear resistance of piston 10 with respect to wear processes, particularly frictional wear processes. It is preferred that the predetermined high wear surface region 19 of piston 10 be selected from a group consisting of a groove surface 17 of an annular groove formed in outer surface 18 of piston 10, such as one of annular grooves 16; a piston skirt surface 15 of piston skirt 14 and a pin bore surface 26 of pin bore 24. High wear region 19 may also be provided with a polymer coating 21. Polymer coating 21 may be utilized to further improve the wear resistance of a piston 10 having high wear region 19 that is Si-rich. Polymer coatings may include any polymer that is adapted to provide enhanced wear resistance to piston 10 and which may be adapted to adhere to Si-rich surface of high wear region 19. Polymer coatings may include epoxy-based polymers, polyamideimide-based polymers and phenolic-based polymers. If utilized, it is preferred that polymer coating 21 also include particles 23 of a solid lubricant dispersed within polymer coating 21. Solid lubricant particles 23 may include graphite, polytetrafluoroethylene, molybdenum disulfide and hexagonal boron nitride (HBN).

Referring to FIG. 2, predetermined high wear region 19 of outer surface 18 is groove surface 17 of annular groove 16 which extends radially and inwardly from the circumferential portion of outer surface 18. For most applications of piston 10, a plurality of annular grooves are formed in crown 12. The present invention is particularly suited for application in the uppermost of annular grooves 16 because this groove is closest to the combustion chamber and experiences the highest operating temperatures and pressures during operation of piston 10, particularly internal combustion engine applications. The present invention is particularly adapted to improve the wear performance of piston 10 by reducing the incidence of microwelding between piston ring 30 and groove surface 17 during the operation of piston 10 in a wide variety of applications, including the use of piston 10 in an internal combustion engine. It is believed that the wear performance improvement is achieved by removal of the lower melting point Al and the fact that the Si-rich surface is harder and less prone to welding with materials typically used for piston ring 30, such as various stainless steels. Further, the Si-rich surface has been observed to be porous, and may be adopted to retain lubricating materials, such as engine oil, used in conjunction with the operation of piston 10. The entirety of groove surface 17 may be made Si-rich by the selective removal of Al as shown in FIG. 1, or the Al may be selectively removed from only a portion of groove surface 17, such as the upper surface, the lower surface or the lateral surface of groove 16 Groove surface 17 may also be coated with polymer coating 21, including disbursed solid lubricant particles 23. The utilization of polymer coating 21 will depend upon the expected operating temperatures of piston 10 and the particular application. If utilized, polymer coating 21 will be selected as best to be adapted to withstand the expected operating temperatures and pressures in the ring groove 16 in which it is utilized.

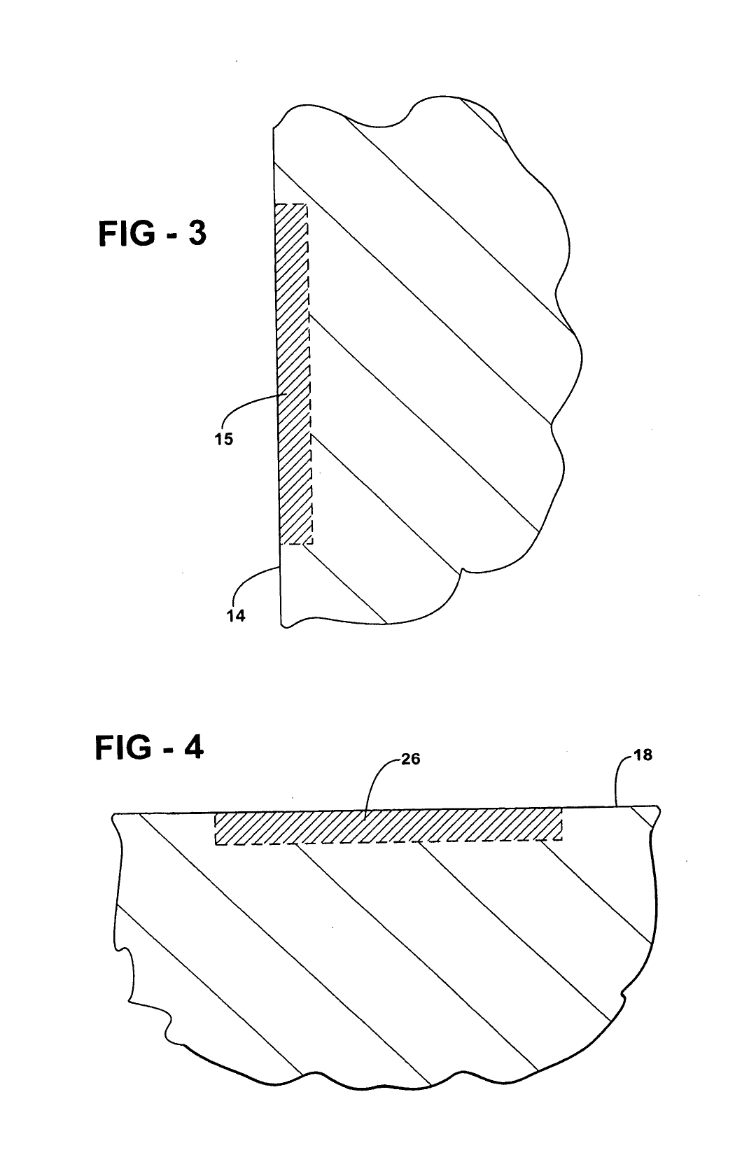

Referring to FIG. 3 the predetermined high wear surface region 19 of outer surface 18 is piston skirt surface 15 of piston skirt 14. This may include the entirety of the surface 15 of piston skirt 14 or may comprise only a predetermined portion 25 of piston skirt surface 15, and may comprise a regular or irregular pattern formed therein, as illustrated in FIGS. 1 and 3. Polymer coating 21, including solid lubricant particles 23, may also optionally be applied to the piston skirt surface 15 of piston skirt 14, including predetermined portion 25 of piston skirt surface 15, as illustrated in FIG. 3.

Referring to FIG. 4, according to the invention, the predetermined high wear surface region 19 may also include piston pin bore surface 26 of piston pin bore 24 formed in each of the pin bosses 22. The pin bore surface 26 may selectively have Al removed, as by etching, so as to be made Si-rich as described above with respect to the Si concentration of the bulk alloy used to form piston 10. Pin bore surface 26 may be made Si-rich with respect to the entirety of pin bore surface 26 or may comprise only a predetermined portion 27 of pin bore surface 26, and may comprise a regular or irregular pattern formed therein, as illustrated in FIGS. 1 and 4.

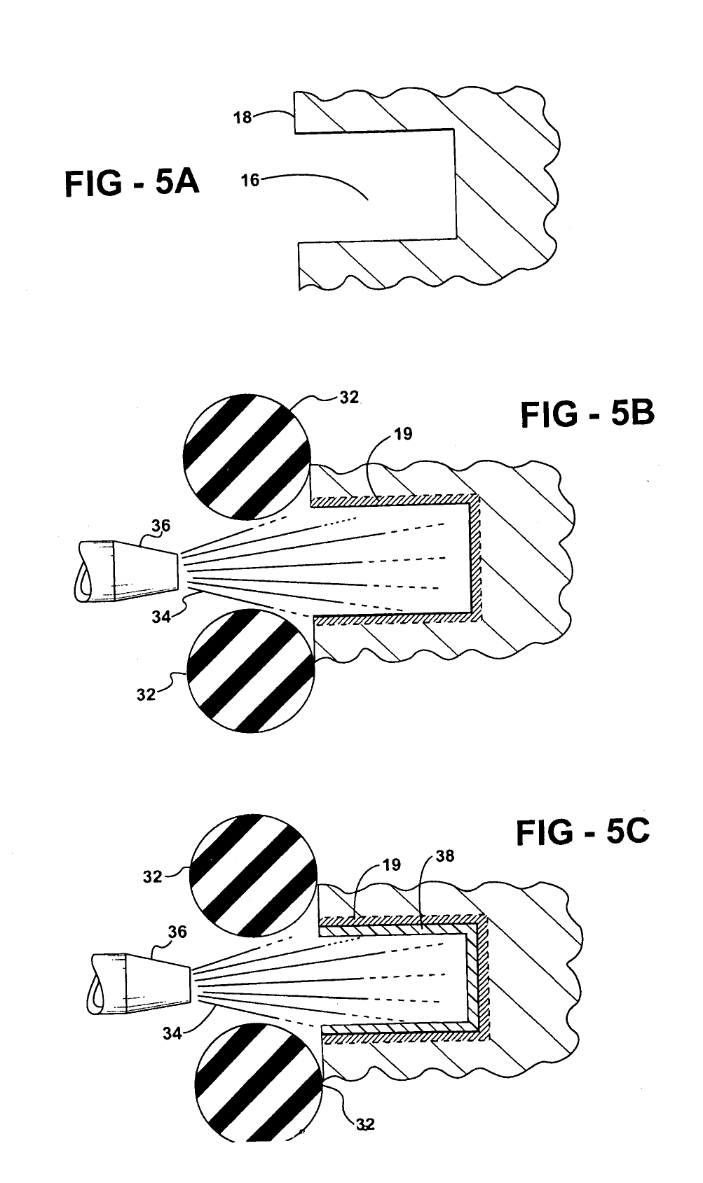

Referring to FIGS. 5A-5C, the invention includes a method 100 of making a piston 10, comprising the steps of: forming 110 (not shown) a piston from an Al—Si alloy having an average concentration of Si in the alloy; finishing 120 a predetermined high wear surface of the piston into a near-net form, such as ring groove 16; and selectively removing 130 Al from the predetermined high wear surface region 19 to form a surface which has an Si concentration which is greater than the average Si concentration of the alloy. Method 100 may also optionally include a step of applying 140 a polymer coating 21 to the predetermined high wear surface region 19. These steps are described in further detail below.

The step of forming 110 the piston 10 from an Al—Si alloy having an average concentration of Si in the alloy may be preformed by any suitable forming method. Methods frequently employed include casting or extrusion of a precursor form of piston 10. The precursor form is then machined to provide features such as ring groove, 16, pin bosses 22, pin bores 24 and combustion bowl 28. The amount of machining required will depend upon the forming method used to form the precursor piston form. Cast pistons may have most of the features cast in a near net form that will be finished by various machining and other surface finishing operations, whereas extruded precursor piston forms may require machining of essentially all of the features described above. The forming of the precursor piston forms and machining and other finishing operations for pistons 10 are well known.

Upon forming 110 of the piston 10, method 100 proceeds with finishing a predetermined high wear surface region of the piston 10 into a near-net form. Finishing 120 may be done by any of the number of known finishing methods such as machining, honing, polishing or other known techniques for providing a near-net form of the piston 10 features, such as ring grooves 16, piston skirt 14, and pin bore 24 and combustion bowl 28, particularly the predetermined high wear region 19 portions of the piston 10.

Following the step of finishing 120, method 100 includes the step of selectively removing 130 Al from the predetermined high wear surface region 19 of the piston 10, such as those described herein, to form an Si-rich surface which has an Si concentration which is greater than the average Si concentration of the alloy. Selective removal of Al from the surface of the piston may be preformed by any suitable method for preferentially or selectively removing Al in the surface region. This includes the utilization of chemical etchants that are effective in removing Al, including Al-rich phases, from the outer surface 18 preferentially to Si, including Si-rich phases from the Al—Si alloy. One suitable etchant for utilization according to method 100 include various alkaline etchants, such as KOH and NaOH. This step of selectively removing Al 130 is illustrated in FIG. 5B, wherein the portion of outer surface 18 to be treated, such as annular groove 16, is masked off with respect to the remainder of outer surface 18, such as by a fixture 33 which incorporates O-rings 32 which are well known in the art. A chemical etchant 34, such as KOH or NaOH or any of a number of other well-known etchants which are adapted to selectively remove Al from the matrix of an Al—Si alloy, is applied to the high wear surface region 19. Etchant 34 may be applied by spraying from a nozzle 36 or by immersing annular groove 16 in a chemical etchant, or by any other suitable method of applying etchant 34 to groove surface 19. It is noted that similar methods may be used for any of high wear surface regions 19 described herein and is not limited to selective removal of Al from groove surface 17 of annular groove 16.

Referring to FIG. 5C, following the step of selectively removing 130 Al, it may be desirable for some applications of piston 10, or for all or some of predetermined high wear surface regions 19, to include as part of the method a step of applying 140 polymer coating 21, including solid lubricant particles 23, to the Si-rich surface. While this may be applicable to groove surface 17 as illustrated in FIG. 5C, it is believed to be particularly applicable to and adapted for use with piston skirt surface 15, as such lubricant coatings are currently applied to piston skirts 14, and the Si-rich surface formed using the method of the invention is believed to improve the adherence of such coatings 21 to the piston skirt 14.

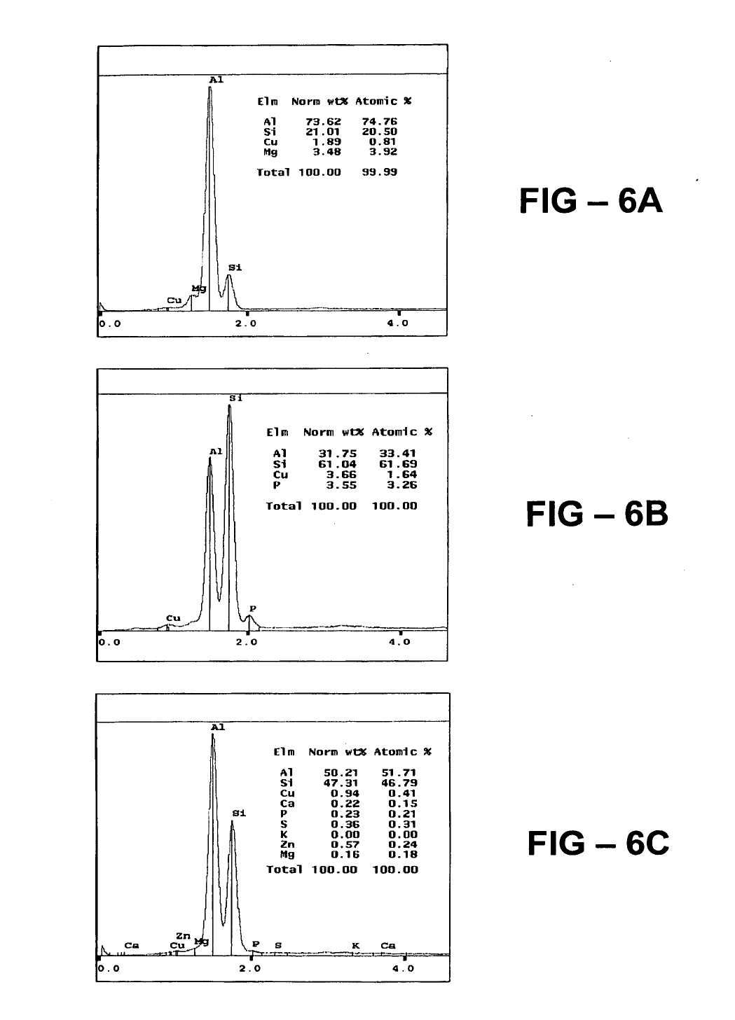

FIGS. 6A-6C illustrate the selective removal of Al from outer surface 18 in a high wear region 19. These figures represent traces from an energy dispersive x-ray (EDX) analysis of portions of outer surface 18 associated with a high wear region 19 comprising an annular groove 16. FIG. 6A is a representative trace taken within an annular groove 16 prior to the selective removal of Al from ring groove surface 15. The concentration of Al at the surface was measured at 73.62 weight percent and the Si concentration at 21.01 weight percent. The Al—Si alloy utilized also included Cu and Mg as alloying additions in the amounts of 1.89% and 3.48% by weight, respectively. FIG. 6B is a trace of an EDX spectra obtained on the ring groove surface 15 of annular ring groove 16 following the selective removal of Al from ring groove surface 15. The concentration of Al has been reduced to 31.75%, while the amount of silicon at the surface is increased to 61.04 weight percent. FIG. 6C is a representative EDX spectra of ring groove surface 15 of annular ring 16 after the selective removal of Al followed by scuff testing of piston 10. Scuff testing involves installing piston 10 in an engine together with a piston ring 30 and connecting rod and reciprocating the piston while operating the engine for a predetermined number of cycles. In this spectra, the Al concentration is 50.21 weight percent while the silicon concentration is 47.31 weight percent, which is consistent with some wear of the Si-rich surface which would be expected in conjunction with the sliding of the piston ring 30 over ring groove surface 15 during the testing.

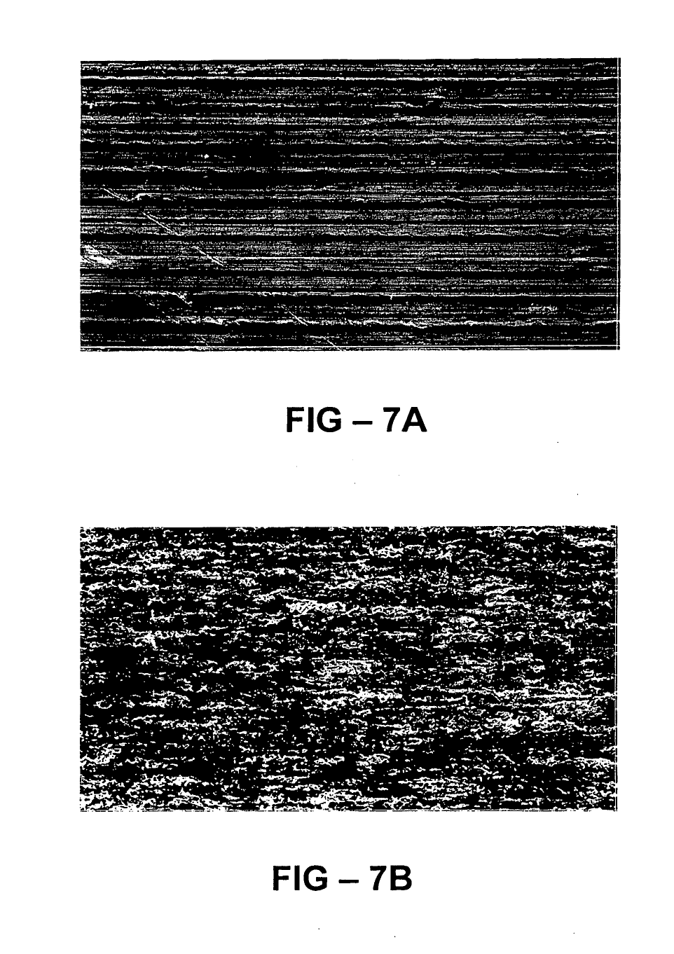

FIG. 7 is a photomicrograph of ring groove surface 15 of annular ring 16 following the finishing of annular ring groove 16, but prior to the selective removal of Al from ring groove surface 15. The photomicrograph was taken at a magnification of 400× using a scanning electron microscope. FIG. 7B is a photomicrograph of ring groove surface 15 of annular ring groove 16 taken from a similar region of the ring groove following selective removal of Al from ring groove surface 15 by chemical etching, as described herein. This photomicrograph was also taken at 400× magnification using a scanning electron microscope. FIG. 7A reveals oriented texture in the form of ridges and valleys or grooves in ring groove surface 15 associated with the machining or other finishing of the surface. FIG. 7 B illustrates that etching has removed a significant amount of texture from this surface leaving a surface which has a greater surface roughness and increased porosity as compared to the surface prior to the selective removal of Al. Representative measurements of such surfaces indicated that the surface of FIG. 7A had a surface roughness of Ra=32.16 nm, Rq=401.80 nm and Rt=2.95 μm. In contrast, the surface illustrated by FIG. 7B had a surface roughness of Ra=840.73 nm, Rq=1.12 μm, Rt=16.29 μm. As may be seen from this representative data, the surface roughness of outer surface 18 in the high wear region 19 subject to the selective removal of Al is substantially greater than that of the as-finished surface.

Obviously, many modifications and variations of the present invention are possible in light of the above teachings. It is, therefore, to be understood that within the scope of the appended claims, the invention may be practiced otherwise than as specifically described. The invention is defined by the claims.

What is claimed is:

1. A piston formed from an Al—Si alloy having an average concentration of Si in the alloy and having a predetermined high wear surface region of the piston having a Si concentration which is greater than the average Si concentration of the alloy.

2. The piston of claim 1, wherein the predetermined high wear surface of the piston is selected from a group consisting of a groove surface of an annular groove formed in the surface of the piston, a surface of a piston skirt and a surface of a pin bore formed in a pin boss of the piston.

3. The piston of claim 1, wherein the predetermined region of the surface comprises a groove surface of an annular groove formed in the surface of the piston.

4. The piston of claim 1, wherein the annular groove is a compression groove which is adapted to receive a piston ring.

5. The piston of claim 1, wherein the predetermined region of the surface is a surface of a piston skirt.

6. The piston of claim 1, wherein the predetermined region of the surface is an annular surface of a pin boss bore which is adapted to receive a piston pin.

7. A piston formed from an Al—Si alloy having an average concentration of Si and an annular surface, the annular surface having a radially inwardly extending groove formed therein having a grooved surface which has a Si concentration which is greater than the average Si concentration of the alloy.

8. A piston formed from an Al—Si alloy having an average concentration of Si in the alloy, said piston having a piston skirt with a skirt surface having a Si concentration which is greater than the average Si concentration of the alloy.

9. The piston of claim 8, wherein a polymer coating is applied to the skirt surface.

10. A piston formed from an Al—Si alloy having an average concentration of Si and a piston pin boss bore having a bore surface which has a Si concentration which is greater than the average Si concentration of the alloy.

11. A method of making a piston, comprising:
forming a piston from an Al—Si alloy having an average concentration of Si in the alloy;
finishing a predetermined high wear surface of the piston into a near-net form;
selectively removing Al from the surface of the predetermined region to form a surface which has a Si concentration which is greater than the average Si concentration of the alloy.

12. The method of claim 11, wherein the predetermined region is selected from a group consisting of a groove surface of an annular groove formed in the surface of the piston, a surface of a piston skirt and a surface of a pin bore formed in a pin boss of the piston.

13. The method of claim 12, further comprising the step of: applying a polymer coating to the surface of the predetermined region.
